(19) United States
(12) Patent Application Publication
(10) Pub. No.: US 2020/0406679 A1
(43) Pub. Date: Dec. 31, 2020

(54) WHEEL BLANK DISCHARGING POSITION DETECTING DEVICE

(71) Applicant: CITIC Dicastal Co., Ltd., Qinhuangdao (CN)

(72) Inventors: Weidong LIU, Qinhuangdao (CN); Shiwen XU, Qinhuangdao (CN); Minglei LI, Qinhuangdao (CN)

(21) Appl. No.: 16/705,145

(22) Filed: Dec. 5, 2019

(30) Foreign Application Priority Data
Jun. 27, 2019 (CN) 2019105654902

(51) Int. Cl. B60B 31/06; B60B 29/00

(52) U.S. Cl. CPC B60B 31/06; B66F 3/24; B60B 29/001

(57) ABSTRACT

The disclosure discloses a wheel blank discharging position detecting device which comprises a frame, wherein a clamping system, a detecting system and a positioning system are arranged on the frame, and the detecting system comprises a distance sensor arranged on the frame above the clamping system; the positioning system comprises a detector arranged on the frame, and the device is simple to operate and improves the machining yield.

### FIELD

The disclosure relates to the technical field of wheels, in particular to a wheel blank discharging position detecting device.

### BACKGROUND

In the automobile wheel production industry, with the increasing labor cost, the automation degree of the production process is required to be higher and higher, and the process for processing the wheels by using the robot is more and more mature. In the process of robotic automatic wheel processing, in order to meet the requirement of full-automatic replacement, before the robot sends a blank into a machine tool for processing, because the end face of the lip end face of the wheel blank is deformed, if the blank is not selected and is directly placed on the machine tool, a large number of wheels would have the defects of cutting deviation, wide and narrow sides at front face and the like, resulting in lower machining yield.

### SUMMARY

In view of the above, the present disclosure aims to a wheel blank discharging position detecting device, which can improve the machining yield.

In order to achieve the above object, the technical solution of the invention is realized as follows:

A wheel blank discharging position detecting device, comprises a frame, is characterized in that: the frame is provided with a clamping system, a detecting system and a positioning system,

the clamping system comprises a cylinder fixed on the frame, a connecting plate is fixed at the output end of the cylinder, a servo motor and a rotating base are fixed on the connecting plate, a rotating shaft is rotationally connected in the rotating base, the output end of the servo motor is connected with the rotating shaft through belt transmission, and a wheel center hole jacking member is fixed on the rotating shaft;

the detecting system comprises a distance sensor arranged on the frame above the clamping system;

the positioning system comprises a detector arranged on the frame.

In one embodiment, a driven gear is fixed on the rotating shaft, a power gear is fixed at the output end of the servo motor, and the power gear is connected with the driven gear through a driving belt.

In one embodiment, the wheel center hole jacking member comprises a base fixed on the driven gear, a limiting block is fixed on the top surface of the base, an umbrella-shaped jacking core is arranged in the middle of the limiting block in a penetrating mode, an elastic element is arranged between the top of the umbrella-shaped jacking core and the upper portion of the limiting block, and a limiting element is arranged between the middle and/or the bottom of the umbrella-shaped jacking core and the limiting block.

In one embodiment, the elastic element comprises a spring sleeved on the umbrella rod of the umbrella-shaped jacking core, wherein one end of the spring is abutted against the umbrella cover of the umbrella-shaped jacking core, and the other end of the spring is abutted against the upper portion of the limiting block.

In one embodiment, a groove extending axially is formed in the middle portion of the periphery of the umbrella-shaped jacking core, and a limiting screw matched with the groove is arranged in the middle portion of the jacking core base.

In one embodiment, a limiting block is further comprised between the bottom of the umbrella-shaped jacking core and the lower portion of the jacking core base.

In one embodiment, the detecting system further comprises a servo motor II and a linear guiding rail which are fixed on the frame, wherein the output end of the servo motor II is fixedly connected with a ball screw, a guiding rail sliding seat is provided on the linear guiding rail, the ball screw penetrates through a screw nut fixed on the guiding rail sliding seat, a sensor bracket is fixed on the screw nut, and the distance sensor is fixed on the sensor bracket.

In one embodiment, the detector comprises an X-ray detector.

Compared with the prior art, the wheel blank discharging position detecting device has the following advantages that:

the wheel blank discharging position detecting device according to the present disclosure is simple in structure and convenient to operate, and meanwhile, the yield of machined semi-finished products is increased.

### BRIEF DESCRIPTION OF THE DRAWINGS

The accompanying drawings forming a part of the present disclosure are used to provide a further understanding of the present disclosure, and the schematic embodiments and the descriptions of the present disclosure serve to explain the present disclosure and do not constitute an improper limitation of the present disclosure. In the drawings:

FIG. 1 is a schematic view of the working structure of the wheel blank discharging position detecting device according to the present disclosure;

FIG. 2 is a schematic view of the working structure of the wheel blank discharging position detecting device according to the present disclosure;

### DESCRIPTION OF THE REFERENCE NUMERALS

bracket, 2-cylinder, 3-guiding shaft base, 4-linear bearing, 5-circlip for hole, 6-guiding shaft, 7-lifting shaft, 8-connecting plate, 9-motor mounting frame, 10-servo motor, 11-planetary gear reducer, 12-gear shaft, 13-power gear, 14-frame, 15-conveying roller, 16-umbrella-shaped jacking core, 17-X-ray detector, 18-copper sleeve, 19-spring, 20-jacking core base, 21-limiting block, 22-X-ray detector mounting frame, 23-base, 24-driven gear, 25-driving belt, 26-gland, 27-radial bearing, 28-spacer ring, 29-pressure bearing, 30-rotating shaft, 31-rotating base, 32-servo motor II, 33-ball screw, 34-screw nut, 35-linear guiding rail, 36-guiding rail sliding seat, 37-sliding seat, 38-sensor bracket, 39-distance sensor, and 40-wheel blank.

### DETAILED DESCRIPTION OF THE EMBODIMENTS

It should be noted that the embodiments and the features in the embodiments of the present disclosure may be combined with each other without conflict.

The technical solution of the present disclosure will be described more clearly and completely with reference to the accompanying drawings in conjunction with the embodiments, and it is apparent that the described embodiments are only some but not all embodiments of the present disclosure. All other embodiments which can be obtained by a person with ordinary skill in the art without making any creative work based on the embodiments of the present disclosure belong to the claimed scope of the present disclosure.

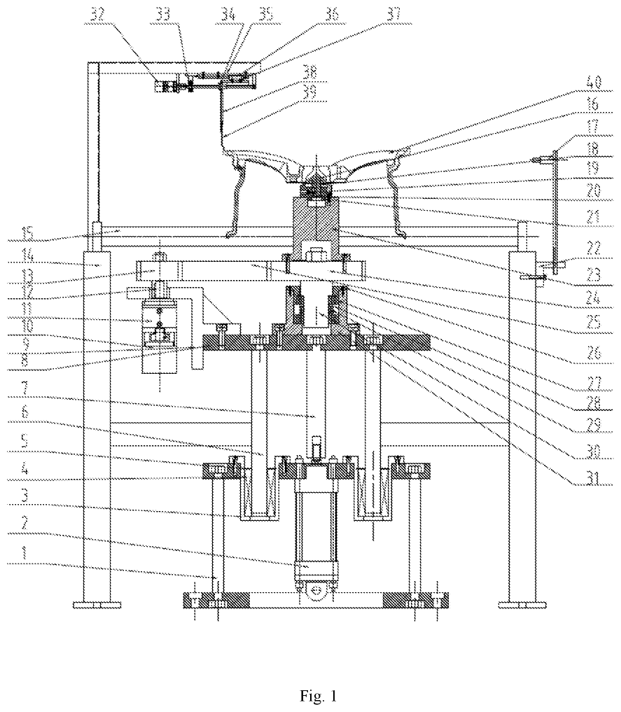

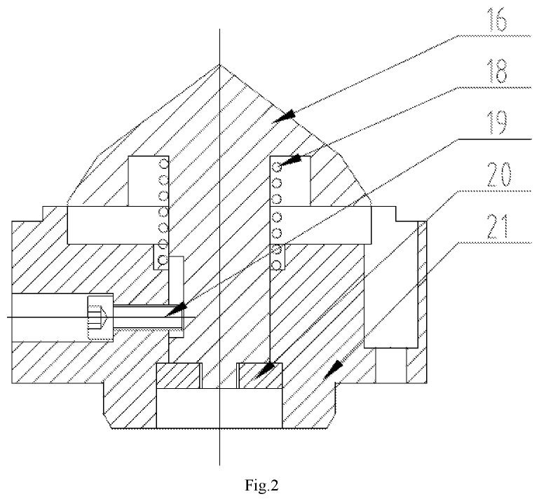

A wheel blank discharging position detecting device according to an embodiment of the present disclosure will be described with reference to FIG. 1 and FIG. 2 in conjunction with the embodiment.

A wheel blank discharging position detecting device comprises a frame, wherein the frame is provided with a clamping system, a detecting system and a positioning system,

the clamping system comprises: a bracket 1 and the frame 14 are fixed on a foundation, and a conveying roller 15 is arranged on the frame 14; a cylinder 2 and a guiding shaft base 3 are fixed on the bracket 1; a linear bearing 4 and a guiding shaft 6 are enclosed in the guiding shaft base 3 through the guiding shaft base 3 and a circlip 5 for a hole; the other end of the guiding shaft 6 is fixed on a connecting plate 8, one end of a lifting shaft 7 is connected with the cylinder 2, and the other end of the lifting shaft 7 is fixed on the connecting plate 8. A rotating base 31 and a motor mounting frame 9 are arranged on the connecting plate 8, and a radial bearing 27, a pressure bearing 29 and a spacer ring 28 are enclosed inside the rotating base 31 through a gland 26 and the rotating base 31; a rotating shaft 30 is arranged on the rotating base 31, and a driven gear 24 is arranged on the rotating shaft 30; a servo motor A10 and a planetary gear reducer 11 are arranged on the motor mounting frame 9, the planetary gear reducer 11 and a power gear 13 are connected through a gear shaft 12, and a driving belt 25 is connected with the power gear 13 and the driven gear 24. The base 23 is fixed on the driven gear 24, a jacking core base 20 is mounted on the base 23, and the rotating shaft 30 and the power gear 13 drive the driven gear 24 to rotate through the driving belt 25; a spring 18 and an umbrella-shaped jacking core 16 are enclosed inside the jacking core base 20 by a limiting block 21, a limiting screw 19 and the jacking core base 20. A mounting frame for an X-ray detector 17 is mounted on the frame 14, and the X-ray detector 17 is mounted on the X-ray detector mounting frame 22.

In one embodiment, the cylinder 2 is mounted on the bracket 1, and the cylinder 2 and the lifting shaft 7 can control the connecting plate 8 to ascend and descend so as to drive the rotating part and the blank detecting part to move up and down.

In one embodiment, the guiding shaft base 3 is mounted on the bracket 1, the linear bearing 4 and the guiding shaft 6 are enclosed inside the guiding shaft base 3 through the circlip 5 for a hole, and the four guiding shafts 6 ensure smooth movement of the rotating part and the positioning part and prevent the connecting plate 8 from rotating circumferentially.

In one embodiment, the driving belt 25 connects the power gear 13 and the driven gear 24, and the driven gear 24 can drive the floating positioning portion to rotate through the servo motor A10, the planetary gear reducer 11, the gear shaft 12, the power gear 13 and the driving belt 25.

In one embodiment, the driven gear 24 is mounted on top of the rotating shaft 30, the base 23 is mounted on the driven gear 24, and the driven gear 24 can drive the rotating shaft 30 and the base 23 to rotate.

In one embodiment, the jacking core base 20 is fixed on the base 23, the jacking core base 20 encloses the spring 18 and the umbrella-shaped jacking core 16 inside the jacking core base 20 through the limiting block 21 and the limiting screw 19, the spring 18 is arranged in the middle of the jacking core base 20, and the umbrella-shaped jacking core 16 can smoothly float up and down under the action of the spring 18.

In one embodiment, the umbrella-shaped jacking core 16 is provided with a groove at the middle position, and the floating range of the umbrella-shaped jacking core 16 can be limited by the match of the groove with the limiting screw 19 and the jacking core base 20, and the umbrella-shaped jacking core 16 can be prevented from rotating circumferentially, so that the positioning precision of the blank is ensured.

In one embodiment, the top of the umbrella-shaped jacking core 16 has a structure with two conical surfaces, wherein the first conical surface is mainly used for guiding, and the second conical surface is in contact positioning with the central hole portion of the wheel blank.

In one embodiment, because the umbrella-shaped jacking core 16 can float up and down, one umbrella-shaped jacking core 16 can be suitable for the positioning requirements of all wheel blanks with the size of the central hole portion within a certain range, so that the generalization of the umbrella-shaped jacking cores 16 is realized, and the production cost is saved.

In one embodiment, the X-ray detector mounting frame 22 is mounted on the frame 14, and the X-ray detector 17 is mounted on the X-ray detector mounting frame 22, wherein the height of the X-ray detector 17 on the X-ray detector mounting frame 22 can be adjusted.

The detecting system and the positioning system comprise a servo motor II 32, a linear guiding rail 35 and a ball screw 33 which are mounted on the roller bed frame 14, and the output shaft of the servo motor II 32 is connected with the ball screw 33; a sliding seat 37 is connected with the linear guiding rail 35 through a guiding rail sliding seat 36; a screw nut 34 is mounted on the sliding seat 37 and engaged with the ball screw 33; and a distance sensor 39 is mounted on the sliding seat 37 via a sensor bracket 38.

Through the meshing fit of the ball screw 33 and the screw nut 34, and the control system uses the pre-programmed running program, the electric control system can control the positive and negative rotation and the revolution of the servo motor II 32, so that the distance sensor 39 runs to the position right above the wheel lip end face of the wheel blank 40. At this time, the servo motor 10 starts to work to drive the rotating shaft 30, the floating positioning portion and the wheel blank 40 to rotate for one circle, a data analysis system obtains n distance values (n is an integral multiple of 3, n is greater than 6) from the distance sensor 39 to the wheel blank 40, wherein each detection value position respectively corresponds to n uniformly distributed positions on the end face of the whole wheel lip of the wheel blank 40. A mean square deviation represents a measure of the dispersion degree of a group of data in the mean value, wherein a smaller mean square deviation represents that these data are closer to the mean value, and the meaning here is that the deformation amount of the wheel lip position of the wheel blank 40 corresponding to the three detection values is smaller. The method for calculating the mean square deviation is that if a certain group of values in n/3 groups of detection values have n1, n2 and n3, the mean square deviation of the group is \sqrt{(n₁-x)²+(n₂-x)²+(n₃-x)²}; the data analysis system statistically analyzes the average value x of n distance values, divides the n detection values into n/3 groups, wherein the angles among the positions on the end face of the wheel lip of the wheel blank 40 corresponding to the three values in each group are 120 degrees, then analyzes and calculates the mean square deviation of the relative average value x in the n/3 groups of detection values, and selects the minimum mean square deviation, wherein this group of data corresponds to the three positions of the wheel blank 40, namely, the positioning surface with the minimum deformation of the end face of the wheel lip, that is the optimal position of the blank discharging position, then analyzes the relative position of the optimal positioning surface relative to the valve hole of the wheel blank 40 through the X-ray detector 17, then the control system controls the steering and the revolution of the servo motor 10, and the optimized positioning surface of the wheel blank 40 is transferred to the mechanical hand grabbing position. And at this time, the optimal selection work of the blank machining and discharging position is finished.

1. A wheel blank discharging position detecting device, comprising a frame, wherein: the frame is provided with a clamping system, a detecting system and a positioning system,
the clamping system comprising a cylinder fixed on the frame, a connecting plate being fixed at the output end of the cylinder, a servo motor and a rotating base being fixed on the connecting plate, a rotating shaft being rotationally connected in the rotating base, the output end of the servo motor being connected with the rotating shaft through belt transmission, and a wheel center hole jacking member being fixed on the rotating shaft;
the detecting system comprising a distance sensor arranged on the frame above the clamping system;
the positioning system comprising a detector arranged on the frame.

2. The wheel blank discharging position detecting device according to claim 1, wherein: a driven gear is fixed on the rotating shaft, a power gear is fixed at the output end of the servo motor, and the power gear is connected with the driven gear through a driving belt.

3. The wheel blank discharging position detecting device according to claim 2, wherein the wheel center hole jacking member comprises a base fixed on the driven gear, a limiting block being fixed on the top surface of the base, an umbrella-shaped jacking core being arranged in the middle of the limiting block in a penetrating mode, an elastic element being arranged between the top of the umbrella-shaped jacking core and the upper portion of the limiting block, and a limiting element being arranged between the middle and/or the bottom of the umbrella-shaped jacking core and the limiting block.

4. The wheel blank discharging position detecting device according to claim 3, wherein the elastic element comprises a spring sleeved on the umbrella rod of the umbrella-shaped jacking core, wherein one end of the spring is abutted against the umbrella cover of the umbrella-shaped jacking core, and the other end of the spring is abutted against the upper portion of the limiting block.

5. The wheel blank discharging position detecting device according to claim 4, wherein a groove extending axially is formed in the middle portion of the periphery of the umbrella-shaped jacking core, and a limiting screw matched with the groove is arranged in the middle portion of the jacking core base.

6. The wheel blank discharging position detecting device according to claim 5, wherein a limiting block is further comprised between the bottom of the umbrella-shaped jacking core and the lower portion of the jacking core base.

7. The wheel blank discharging position detecting device according to claim 2, wherein the detecting system further comprises a servo motor II and a linear guiding rail which are fixed on the frame, wherein the output end of the servo motor II is fixedly connected with a ball screw, a guiding rail sliding seat is provided on the linear guiding rail, the ball screw penetrates through a screw nut fixed on the guiding rail sliding seat, a sensor bracket is fixed on the screw nut, and the distance sensor is fixed on the sensor bracket.

8. The wheel blank discharging position detecting device according to claim 2, wherein the detector comprises an X-ray detector.
